(19) United States
(12) Patent Application Publication
(10) Pub. No.: US 2008/0016504 A1
(43) Pub. Date: Jan. 17, 2008

(54) Dynamically programmable electronic data collection system combining declarative programming and native coding

(76) Inventors: Wesley Homer Cheng, Palo Alto, CA (US); Kenneth Ashley Ebbs, Los Altos, CA (US); Kevin Ray Mathis, Harrison, AR (US)

Correspondence Address: TRAN & ASSOCIATES, 6768 MEADOW VISTA CT., SAN JOSE, CA, 95135, US

(21) Appl. No.: 11/486,468

(22) Filed: Jul. 14, 2006

(51) Int. Cl. G06F 9/44

(52) U.S. Cl. 717/168

(57) ABSTRACT

Systems and methods provide a dynamically updateable mobile client in communication with a server by generating one or more application resources; generating native code to run on a mobile client device to log the driver work flow; transmitting the application resources and the native code to the mobile client device; executing the native code on the mobile client device; and dynamically updating the native code on demand.

### BACKGROUND

The present invention relates to electronic logging of data.

Truck drivers across the United States presently operate under regulations promulgated by the Department of Transportation (DOT) and the Federal Motor Carrier Safety Administration (FMCSA). The DOT and FMCSA regulate many aspects of the transportation industry ranging from vehicle maintenance to substance abuse. One of the more important areas that the DOT and FMCSA monitor is the occurrence of truck-related accidents and ways to reduce the number of such accidents.

Driver fatigue has been cited by the DOT and FMCSA as being one of the primary causes of truck-related accidents. Consequently, the FMCSA has adopted regulations that limit the number of hours that truck drivers may operate a vehicle over a given time period. For example, the DOT prohibits any driver from driving a commercial vehicle in excess of 10 hours and requires 8 hours of rest prior to driving again.

To ensure compliance with these safety regulations, the FMCSA also requires drivers to keep detailed written records of the number of hours: (1) driving; (2) on-duty not driving; (3) resting, and; (4) off-duty. Drivers must provide daily updates into a logbook carried with the driver, detailing the number of hours spent in each of the four categories mentioned above. Other information may be required as well, such as the location of where the log book entry occurred, a vehicle identification number, the name of the nearest city at the time of a logbook entry, and so on. A driver must make entries into the log book each time the driver: (1) begins driving; (2) stops driving; (3) starts or ends an “on-duty not driving” period, and; (4) starting or ending a period of rest. Drivers are mandated by federal rules to chart their hours and activities every day by drawing lines on a grid in the log book and calculating the number of hours driving, on-duty not driving, resting, and off duty, over a twenty four hour period.

Federal officials periodically inspect driver logbooks at weigh stations and other locations to certify that they have been kept up-to-date by the driver, and that the driver is following the FMCSA mandated regulations. If a driver is found to be out of compliance with the FMCSA regulations, he or she will not be permitted to continue driving until the proper amount of off-duty or rest time has elapsed. This results in late deliveries to customers and general inefficiency for the driver's employer. The driver is also penalized because the mandated “rest” time affects the hours that he/she is able to work. If a number of violations occur over a given time period, substantial fines may be levied against the driver and/or employers.

The logbooks are a nuisance for drivers to fill out and keep current. Consequently, entries are often neglected until well after the time they were supposed to be entered. This may result in erroneous entries, since the driver must rely on memory as to the timing of recordable events. Inaccurate entries into the logbook may be discovered during an audit of the carrier's records by FMCSA officials months, or even years, later.

The logbooks are also susceptible to intentional misrepresentation by vehicle operators. Commercial vehicle operators are sometimes paid by the number of loads delivered, so there is a great incentive for operators to intentionally under-report the hours that they have driven, or to over-report the number of rest hours between driving periods.

To address the logging requirement, U.S. Pat. No. 6,317,668 describes a system and method for automatically calculating safety-related compliance data for vehicle operators. Vehicle operators enter an identification code and status information into a mobile communication terminal located on a vehicle. The identification code and status information is generally stored in a memory located within the mobile communication device. The identification code and status information can be transmitted to a central station where it can be processed to determine compliance with safety regulations. The resulting data may be transmitted back to the vehicle upon request. In another embodiment, a processor located within the mobile communication terminal processes the identification code and status information. The resultant data may then be transmitted to the central station or presented to the vehicle operator upon request.

Typically, electronic driver log (e-log) applications are either hard coded and the logic sealed within a device, or use forms which have limited ability to articulate sophisticated business logic.

FIG. 1 shows a conventional process for hard-coding software to handle driver logging. In FIG. 1, a client machine receives a custom application (1.1) and the application typically runs with a device operating system (1.2). Typically, a code editor is used to generate code specific to a client (1.3). The code can be stored on a server and the executable can be downloaded to a client machine (1.4). In a hard coded client, the user enters data into the client and the data is sent in a predefined manner without any selection from the truck operator.

FIG. 2 shows a conventional forms based system having forms 2.1 on a client machine. The forms 2.1 are housed in a forms container 2.2. The container 2.2 operates with a device operating system 2.3. The forms 2.1 are edited by a forms editor 2.4, which can run on a server. The forms 2.1 are sent from the server over a network 2.5 to the client machine.

U.S. Pat. No. 6,526,341 describes a forms based client that transmits data between vehicle and central station using predefined forms or messages called macros. Each macro is a predefined “form” or “template” which contains blank information fields to be filled out by the vehicle operator or a central station employee, as the case may be. The advantage of using macros in a wireless communication system is a reduction in message length, corresponding to a decrease in messaging costs. For example, in the exemplary embodiment, a predefined macro looks like:
I HAVE RECEIVED LOAD INFORMATION AND ON MY WAY. ETA TO SHIPPER IS: DATE ______ TIME ______. I HAVE TRAILER ______, LICENSE NUMBER ______. I NEED DIRECTIONS TO NEXT STOP Y/N.

Rather than transmitting the entire text message above, a vehicle operator simply enters information in the blank fields, and transmits only the information contained within the fields, along with a macro identification number that indicates to central station that the information contained within the present message corresponds to a macro. At central station, the information is extracted from the received message in accordance with the structure of the macro. Many other macros are used in modern satellite communication systems today, including macros which indicate arrival at a consignee, vehicle stuck in traffic, trailer loaded, trailer unloaded, and so on. When a vehicle operator desires to transmit a macro message, one of the predefined macros is chosen, and any blank fields contained within the macro are filled with the appropriate information by the vehicle operator, or automatically by the client. For example, the vehicle's current position may be automatically entered by a processor after obtaining location information from a position location device, and appending the location information to the macro message. Position location devices may be any device well-known in the art for determining the location of a vehicle, such as a device based on the well-known Global Positioning System (GPS). After the blank fields of the macro message have been completed, the message is formatted into an appropriate transmission protocol by the client, then transmitted to a central station using a transceiver such as a Land Mobile Radio (LMR), a cellular telephone, or a satellite transceiver.

### SUMMARY

In one aspect, systems and methods provide a dynamically updateable mobile client in communication with a server by generating one or more application resources; generating native code to run on a mobile client device to log the driver work flow; transmitting the application resources and the native code to the mobile client device; executing the native code on the mobile client device; and dynamically updating the native code on demand.

Implementations of the above aspect may include one or more of the following. The user can edit the application resources using a resource editor and can edit the source code using an editor. The system can compile the one or more application resources and a source code. The application resources and the native code can reside on a server. The system can transmit the one or more application resources and the native code over a wide area network. The one or more application resources can be received in an application container on the mobile client device. An application updater can be used to update an application container. The application updater can access a new native code module. The application container can access an original native code module. The application updater can access a new native code module and the application container can access an original native code module in replacing the original native code module with the new code module. During operation of the resulting client-server application, the native code client application sends or receives data to/from the server, wherein the client application is code native to the mobile device and the server application is a different code (e.g. Java), and wherein the client application translates the data to a language neutral format, then encapsulates the data into a message, then sends message to server which then translates the data to its native language.

In another aspect, a system includes code running on a computer to generate one or more application resources; code running on the computer to generate native code to run on a mobile client device; a network to transmit the application resources and the native code to the mobile client device; and a processor executing the native code on the mobile client device, the processor dynamically updating the native code on demand. Implementations of the above aspect may include one or more of the following. The system includes code to edit the application resources using a resource editor. The system also includes code to edit a source code using an editor. The application resources and the native code can reside on the computer. Code can be executed to transmit the one or more application resources and the native code over a wide area network. An application container on the mobile client device receives the one or more application resources. An application updater updates an application container. The application updater accesses a new native code module and wherein the application container accesses an original native code module, wherein the mobile device replaces the original native code module with the new code module.

Advantages of the above system may include one or more of the following. The system allows new logs to be generated and downloaded on the fly to the mobile device. Such updatable system is convenient to use for company with large fleets that may be all over the country. The updated form allows fresh data to be collected and distributed virtually at will and allows the shipping company to be more nimble and more responsive to market forces. The system allows the fleet operator to operate at the speed of the Internet.

### BRIEF DESCRIPTION OF THE DRAWINGS

FIG. 1 shows a conventional process for developing hard-coded software for driver logging.

FIG. 2 shows a conventional process for handling forms on a client machine.

FIG. 3 shows an exemplary operating environment for electronically tracking driver logs.

FIG. 4 illustrates an exemplary method of performing electronic driver log applications.

FIG. 5 shows exemplary components of a dynamically programmable electronic driver log system.

FIG. 6 shows an exemplary application resource file and translation by the application container into an application.

FIG. 7 illustrates an exemplary native code updating technique.

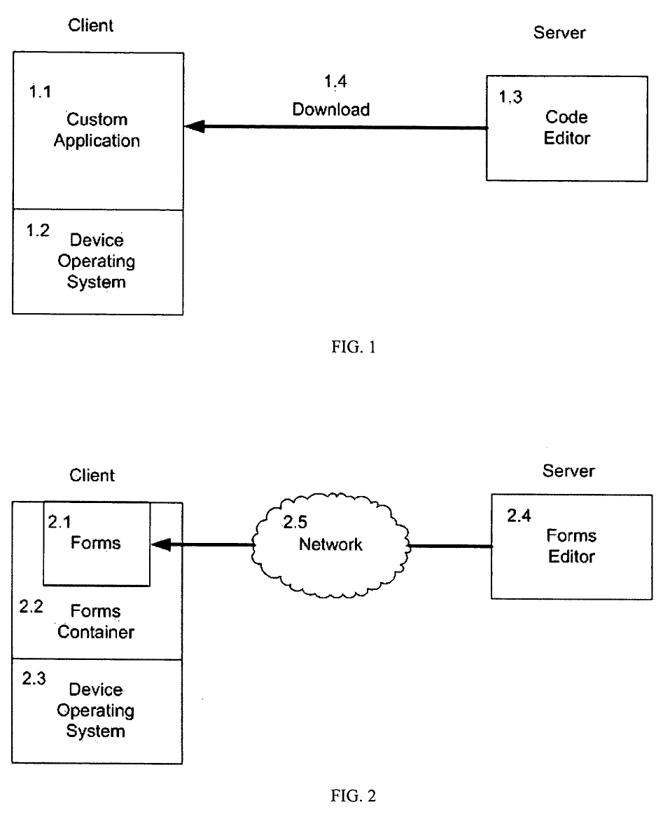

### DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

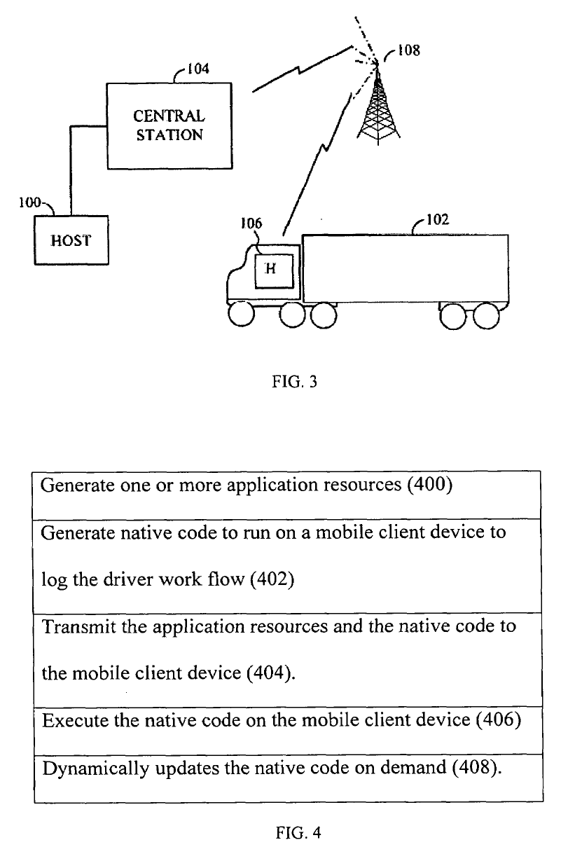

FIG. 3 is an illustration of an exemplary system supporting electronic driver logging. Information is communicated between host facility (or host) 100 and ultimately vehicle 102 in the form of voice and/or data communications. Host 100 communicates information to central station 104 using well known communication channels, such as wireline or wireless telephone channels, fiber optic channels, or the like. Host 100 is typically a freight transportation company, otherwise known as a carrier, owning a large fleet of vehicles that are widely dispersed over a large geographic area. Typically, each vehicle carries a handheld device 106 such as a smart cell phone which can act as mobile communication terminal to enable communications with host 100 by way of cellular towers 108 and central station 104. Alternative communication techniques include satellite communication or dedicated terrestrial radio stations. Although only one host 100 and one vehicle 102 is shown in FIG. 3, in practice, many hosts 100 use central station 104 to communicate information to and from their respective fleet vehicles.

The information sent by host 100 to central station 104 may contain voice or data information that is directed to one or more vehicles in the communication system. Information may also originate from central station 104 independently of host 100. In the case of information being transmitted from host 100, central station 104 receives the information and attempts to forward it to the identified vehicle or vehicles, as the case may be. The particular vehicle or vehicles for which the message is intended is identified by specifying an alpha-numeric code, typically a code corresponding to a serial number which has been pre-assigned to mobile communication terminal 106 installed on vehicle 102. However, any known method may be used to uniquely identify vehicles in the communication system.

In one embodiment, the system includes a Vehicle Interface Module (VIM). The VIM is installed in the vehicle through a plug-in SAE J1962 connector. The VIM includes a microcontroller and memory, a Bluetooth radio, and an SDIO slot for the addition of an optional Key FOB. The VIM provides full access to the vehicle's ECU data and allows the system to access Diagnostic Trouble Codes reported by the vehicle's ECU. The VIM helps users to service and maintain the vehicle with live sensor display. The VIM also reads and displays reason for Check Engine Light or MIL (Malfunction Indicator Light) which indicates presence of fault codes (DTC, Diagnostic Trouble Codes). The VIM can collect data such as Throttle position, Engine RPM, Vehicle speed, Calculated load value, Ignition timing advance, Intake air flow rate, Short term fuel trim, Long term fuel trim, Air temperature, Coolant temperature, Oxygen sensors. The VIM can also display diagnostics trouble codes (DTC), clear Check Engine lamp, retrieve and clear Generic and Manufacturer specific diagnostic trouble codes (DTC), display live sensor data and freeze frame data, and communicates with Engine Management System and Emissions Systems.

The VIM communicates with the handheld device 106, which can be a cell phone or PDA capable of running the J2ME, Windows Mobile, or BREW operating systems. The handheld device 106 is also equipped with Bluetooth and GSM/GPRS, CDMA/1X, or iDEN voice and data communications. Exemplary handheld device 106 can be the Java J2ME cell phones, Nextel i730, i850, i355, i605, Blackberry, Nextel, Verizon Wireless, Cingular, Sprint MS Windows Mobile Smartphone Edition, Nextel, Verizon Wireless, Cingular, Sprint MS Windows Mobile Pocket PC Edition, Nextel, Verizon Wireless, Cingular, Sprint BREW cell phones. The handheld device 106 runs mobile software components 108 such as a Consumer Application (CA). The CA serves as the user interface to vehicle control and configuration functions and OBDII (SAE standard for On Board Diagnostics II for cars and light trucks) data access on the VIM via Bluetooth. The CA also supports the ability to transmit the data, manually or automatically, and receive commands remotely via standard wide area wireless networks.

The VIM can run an OBDII Application Platform (OAP) or SAE J1708/J1939 Adapter (for heavy trucks) written for the VIM that accepts and responds to requests for OBDII/J1708/J1939 data and configuration settings from the consumer application. The OAP or J1708/J1939 Adapter implement a range of OBDII/J1708/J1939 protocols for access to vehicle systems such as the engine, transmission, safety, and chassis. The handheld device also supports an API that enables 3rd party developers to access the VIM.

The handheld device 106 communicates with a server over a wide area network (WAN) such as the Internet. Wireless access to the Internet can be provided through cellular towers 108 that access the Internet through the cellular wireless carriers or service providers that own the towers 108.

In one embodiment, the position of vehicle 102 is provided to central station 104 at predetermined time intervals, such as once per hour, and is commonly referred to as a position report. The position of vehicle 102 may be provided generally in one of two ways. In the exemplary embodiment, the position of vehicle 102 is determined at central station 104 using a positioning unit such as GPS, GLONASS or GALILEO position receiver. These systems are well-known in the art for providing accurate, real time position information, generally in the form of latitude and longitude coordinates, to a GPS receiver located onboard vehicle 102. The position of vehicle 102 as provided by the GPS receiver is transmitted to central station 104 at predetermined intervals. The GPS information may be transmitted alone, or it may be appended to voice or text messages.

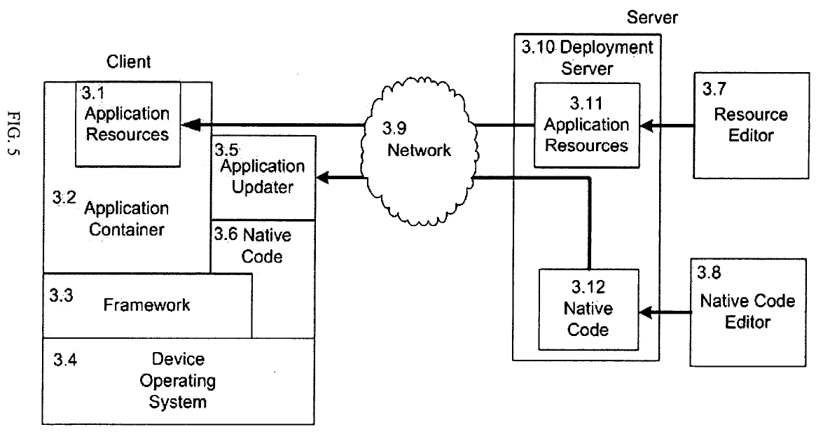

FIG. 4 shows an exemplary method to provide a dynamically updateable driver log. The method includes generating one or more application resources (400) and generating native code to run on a mobile client device to log the driver work flow (402). Next, the method transmits the application resources and the native code to the mobile client device (404). A processor executes the native code on the mobile client device (406) and dynamically updates the native code on demand (408).

In one embodiment, during operation of the resulting client-server application, the native code client application sends or receives data to/from the server. The client application is code native to the mobile device (such as assembly code for ARM, MIP, or 80×86 processor) and is executed by the processor of the mobile device. The formats of the application code objects and related messages are represented in the native language to that device (Java, Brew, or MS C#, for example). The server application runs a different code such as Java. The client application translates the data to a language neutral format, then encapsulates the data into a message, then sends message to server which then translates the data to its native language.

The application may collect data or analyze GPS coordinates and send alerts to the server (and subsequently to some back-office application or system). Alternatively, the application can present a form to the user; collect the inputs from the user; run a calculation and send the results to the server. In other examples; the application can scan a bar code, check it against a server database, then present product details to the user. In yet other examples, the application can collect time and distance data, combine the data with inputs from a driver, then draw a graph for inspection purposes, for example. In general, the system can be a client-server application with the client running on a mobile wireless device.

The process of FIG. 4 allows new logs to be generated and downloaded on the fly to the mobile device. Such updatable system is convenient to use for company with large fleets that may be all over the country. The updated form allows fresh data to be collected and distributed virtually at will and allows the shipping company to be more nimble and more responsive to market forces.

FIG. 5 shows exemplary components of the dynamically programmable electronic driver log. The client side runs on the handheld device 106; examples include a Microsoft PocketPC-based Personal Digital Assistant (PDA), or a Java-based handheld computer. Abstracting the hardware specifics is the Device Operating System (3.4) provided by the hardware manufacturer. The Framework (3.3) is a collection of software components that handle common functionality for the application. This might include things such as: database, event-driven model, plug-in architecture for native code modules. The Application Container (3.2) is the software layer that reads and executes the Application Resources (3.1), which is a set of instructions describing the graphical user interface, workflow and business logic for the e-log application.

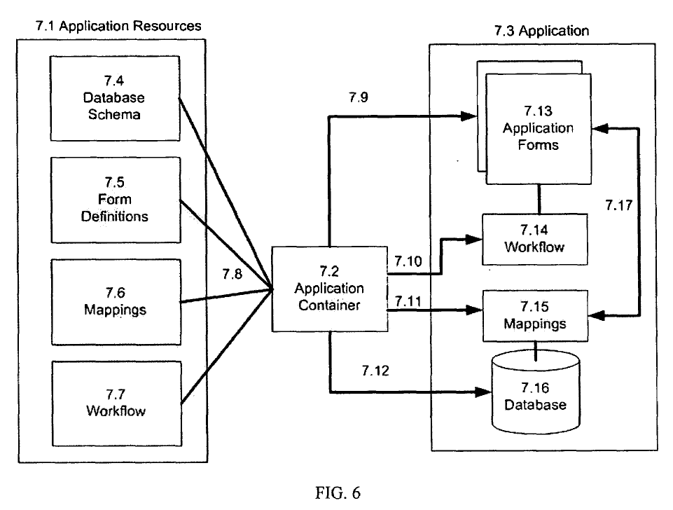

FIG. 6 provides exemplary Application Resources and how they are interpreted by the Application Container to create the Application with which the user interacts. The Application Resources (7.1) can consist of a set of meta data that describes various parts of the Application (7.3). It might include the Database Schema (7.4), the Form Definitions (7.5), the Mappings among the database, forms and messages (7.6), and Workflow (7.7) that describes how one Application Form transitions to another. The Application Resources are interpreted by the Application Container (7.2) that reads each of the meta data and transforms them into actual running application components. The Database Schema (7.4) is used to define the tables in the Database (7.16). The Forms Definitions (7.5) are used to create the graphical components (eg. dialog boxes, text entry boxes, labels, buttons) for the Application Forms (7.13). The Mappings (7.6) are used to generate code or algorithms that take data from one component to another (7.15), for example, taking a row from a table in the database (7.16) and transforming the columns (7.17) into individual text fields in the Application Forms (7.13), perhaps also operating on the data with some mathematical function or using relational grammars to modify the data. Workflow definitions (7.7) are used to create a set of instructions for directing the flow of the application (7.14), which might be modeled as a finite state machine, a jump table, or a flowchart, for example.

A Deployment Server (3.10) can be a software program residing on the server computer that contains the new versions of an application's Resources (3.11) and Native Code (3.12). The Application Container (3.2) and Application Updater (3.5) listen for updates from the Deployment Server. These updates are sent in the form of system messages that are received by the Application Container. When an update message is received, the Application Container pulls over the new Application Resources (3.11) over the network (3.9) and replaces the old Application Resources (3.1) with the new. It also invokes the Application Updater to pull the new Native Code modules (3.12) from the Deployment Server.

The Resource Editor (3.7) is a software program residing on the server computer that allows a programmer to change the declarative (interpreted) parts of the application by editing its Application Resources. For example, there might be a new text field to be added to a form, and a corresponding change in the message to add the value of the text field. The Resource Editor generates a new Application Resources file (3.11) which is then submitted to the Deployment Server (3.10). When the Application Container has received new Application Resources, it can update the behavior of the application instantly because the Resources are interpreted and therefore not stored as a compiled application.

A user may wish to include custom software components that perform special functions. This is referred to as the Native Code (3.6) module and is developed by a programmer using a Native Code Editor (3.8) that compiles code for the Device Operating System (3.4). A Native Code Editor might be Microsoft Visual Studio and the code being developed is done using the C# language, for example. For instance, a Native Code module might interface with a particular modem that checks for hooking/unhooking of containers to a tractor. In this case, native code must be written directly to the Device Operating System (3.4) layer to access the specific and proprietary commands for the modem. These commands will not be known a priori because the modem might be selected at a time after the e-log application has been deployed. Having a way to insert native code thus provides a method to extend the application without limitations of the application model. The Native Code may also call exposed API's of the Framework (3.3) to take advantage of some of the common functionality (eg. Database). The method by which the Native Code is updated on the device is the responsibility of the Application Updater (3.5). The Application Updater is a separate application that runs in parallel with the Application Container. Its purpose is to monitor for updates in the Deployment Server (3.10) and pull down any new Native Code modules (3.12). The method of FIG. 5 provides for combining declarative and native coding techniques for electronic driver log applications.

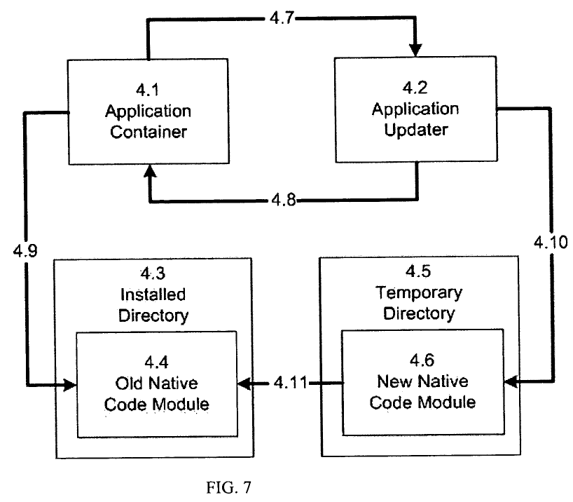

FIG. 7 provides a more detailed diagram of the Native Code update process. The Application Container (4.1) runs the e-log application using which consists of the Application Resources and any Native Code modules. The Application Resources refer to Native Code modules which are instantiated by the Application Container when needed. This late binding technique is available on new interpreted languages such as Java and Microsoft C#. The Native Code modules (4.4) are stored in the Installed Directory (4.3) of the device, which is an area of memory that the Application Container will look for Native Code modules (4.9).

The Application Updater (4.2) takes the New Native Code module (4.6) and replaces the old Native Code module (4.4) with the new version. A module identifier (mid) and version number are associated with each Native Code module by the developer using a Native Code Editor such as Microsoft Visual Studio or Eclipse. The developer enters the mid and version number as a string into the specified “module_ID” and “module_version” fields respectively. The mid field can be any string and must match exactly. The module version must be a number where the newer version must have a number that is higher than the older version. The Application Updater receives the new Native Code module over the Network. Since the Application Container is running, the Application Updater cannot overwrite the older Native Code as the file is locked by the Application Container (4.9).

The Application Updater stores the new Native Code module (4.6) into a temporary directory (4.5). When the Application Container is restarted, it runs (4.7) the Application Updater which first looks in the temporary directory to check for new Native Code modules (4.10). If one is found, it matches the mid and also ensures that the version number is higher than the current module, then shuts down the Application Container (4.8) and replaces the Native Code Module (4.11). If it does not shut down the Application, the old Native Code module file will be locked. Next, the Application Updater starts up (4.8) the Application Container again and the new Native Code module will now be accessed. Finally, the Application Updater removes (4.10) the new Native Code module from the temporary directory and continues listening for new updates from the server.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention. The following claims are intended to encompass all such modifications.

What is claimed is:

1. A method to provide a dynamically updateable mobile client in communication with a server, comprising:
generating one or more application resources;
generating native code to run on a mobile client device;
transmitting the application resources and the native code to the mobile client device;
executing the native code on the mobile client device; and
dynamically updating the native code on demand.

2. The method of claim 1, comprising editing the application resources using a resource editor.

3. The method of claim 1, comprising editing a source code using an editor.

4. The method of claim 1, wherein generating native code comprises compiling the one or more application resources and a source code.

5. The method of claim 1, wherein the application resources and the native code reside on a server.

6. The method of claim 1, comprising transmitting the one or more application resources and the native code over a wide area network.

7. The method of claim 1, comprising receiving the one or more application resources in an application container on the mobile client device.

8. The method of claim 1, comprising providing an application updater to update an application container.

9. The method of claim 8, wherein the application updater accesses a new native code module.

10. The method of claim 8, wherein the application container accesses an original native code module, wherein the application updater accesses a new native code module and wherein the application container accesses an original native code module, comprising replacing the original native code module with the new code module.

11. The method of claim 1, wherein the native code sends data to or receives data from the server, wherein the native code is executed by a mobile device processor, wherein native code translates data from a native language to a language neutral format, encapsulates the language neutral formatted data into a message, and sends the message to a server to translate the data to the native language.

12. A system, comprising:
code running on a computer to generate one or more application resources;
code running on the computer to generate native code to run on a mobile client device;
a network to transmit the application resources and the native code to the mobile client device; and
a processor executing the native code on the mobile client device, the processor dynamically updating the native code on demand.

13. The system of claim 12, comprising code to edit the application resources using a resource editor.

14. The system of claim 12, comprising code to edit a source code using an editor.

15. The system of claim 12, wherein the native code comprises one or more application resources and a source code.

16. The system of claim 12, wherein the application resources and the native code reside on the computer.

17. The system of claim 12, comprising code to transmit the one or more application resources and the native code over a wide area network.

18. The system of claim 12, comprising an application container on the mobile client device to receive the one or more application resources.

19. The system of claim 12, comprising an application updater to update an application container.

20. The system of claim 19, wherein the application updater accesses a new native code module and wherein the application container accesses an original native code module, wherein the mobile device replaces the original native code module with the new code module.

21. The system of claim 12, wherein each application resource comprises a set of meta-data describing an application.

22. The system of claim 21, wherein the meta-data comprises a database schema, a form definition, a database mapping, one or more forms and messages, and a workflow describing a transition from one application form to another.
